(19) United States
(12) Patent Application Publication
(10) Pub. No.: US 2016/0077485 A1
(43) Pub. Date: Mar. 17, 2016

(54) Manually Removable Separator for Neutralizing Static Charge Buildup on a Replaceable Unit of an Electrophotographic Image Forming Device

(71) Applicant: Lexmark International, Inc., Lexington, KY (US)

(72) Inventor: Rodney Evan Sproul, Lexington, KY (US)

(21) Appl. No.: 14/488,490

(22) Filed: Sep. 17, 2014

(51) Int. Cl. G03G 21/16

(52) U.S. Cl. CPC G03G 21/1671; G03G 21/1652

(57) ABSTRACT

A replaceable unit for an electrophotographic image forming device according to one example embodiment includes a photoconductive drum having an outer surface. A component is biased toward contact with the outer surface of the photoconductive drum. A separator is manually removable from the replaceable unit. The separator includes a separator portion physically separating the component from the outer surface of the photoconductive drum. The separator also includes a first electrically conductive contact electrically connected to the component and a second electrically conductive contact electrically connected to the photoconductive drum. An electrical path is formed between the first electrically conductive contact and the second electrically conductive contact electrically connecting the component and the photoconductive drum such that a surface electrical potential of the component remains substantially the same as a surface electrical potential of the photoconductive drum.

### CROSS REFERENCE TO RELATED APPLICATIONS

None.

### BACKGROUND

1. Technical Field

The present disclosure relates generally to electrophotographic image forming devices and more particularly to a manually removable separator for neutralizing static charge buildup on a replaceable unit of an electrophotographic image forming device.

2. Description of the Related Art

Image forming devices such as electrophotographic printers, copiers and multifunction devices commonly include one or more replaceable units that have a shorter lifespan than the image forming device does. As a result, the replaceable unit must be replaced by the user from time to time in order to continue operating the image forming device. For example, an electrophotographic image forming device's main toner supply is typically stored in a replaceable unit. In some devices, other imaging components such as a developer roll, a toner adder roll, a doctor blade, a photoconductive drum and a charge roll are included in the replaceable unit that holds the main toner supply. In other devices, some or all of these imaging components are separated from the toner supply in one or more separate replaceable units referred to as imaging units. In these devices, the image forming device's toner supply, which is consumed relatively quickly in comparison with the components housed in the imaging unit(s), may be provided in a reservoir in a separate replaceable unit in the form of a toner cartridge or bottle that supplies toner to the imaging unit(s). These replaceable units require periodic replacement by the user such as when the toner supply runs out or when the imaging components reach the end of their life due to wear.

Some of the components that are biased against the photoconductive drum during operation of the image forming device (e.g., the developer roll, the charge roll, a cleaner roll, etc.) may tend to chemically damage or physically deform or flatten portions of the photoconductive drum if the components are maintained in unmoved contact with the photoconductive drum for a long period of time such as during storage or shipping. This damage to the photoconductive drum may, in turn, cause print defects. To address this issue, replaceable units having a photoconductive drum are generally stored and shipped with a separator component that physically separates the photoconductive drum from other imaging components. The separator component is then removed by the customer before installation of the replaceable unit into the image forming device.

The replaceable units often include a housing made from plastics such as high impact polystyrene (HIPS) or acrylonitrile butadiene styrene (ABS) polymer. The replaceable units are also frequently shipped to the customer in bags made of polymers such as polyethylene. During shipping and storage of a packaged replaceable unit, small amounts of toner sometimes leak from between its components or seals. A piece of open-cell foam is often wrapped around the replaceable unit during storage or shipping to catch any leaked toner. During transport, plastic on plastic movement between the housing of the replaceable unit and the bag may result in tribocharging of the surfaces of the materials. Shipping vibrations may also cause the foam to rub on both the bag and the plastic housing of the replaceable unit which can result in a buildup of static charge of up to several thousand volts. When a customer opens the packaging and removes the replaceable unit from the bag, this static buildup may be discharged by the person or another object resulting in a very quick change in electric potential for one of the surfaces of the photoconductive drum or one of the imaging components separated from the photoconductive drum. Since the surfaces of the photoconductive drum and the separated imaging component are no longer at the same electric potential, another electrostatic discharge may occur between the two components when they are brought into contact or close proximity with each other when the separator component is removed. This electrostatic discharge between the photoconductive drum and another component may cause spots, lines or other defects on the surface of the photoconductive drum that may, in turn, cause a print defect.

Previous attempts to mitigate this issue, such as using alternative materials for the shipping bag, are costly. Other methods to cancel static charge buildup tend to increase the risk of toner leakage. Accordingly, there remains a need for a cost-effective system to reduce the potential print quality defects caused by electrostatic discharge on the surface of the photoconductive drum.

### SUMMARY

A manually removable separator for a replaceable unit of an electrophotographic image forming device according to one example embodiment includes a separator portion positioned to physically separate a component of the replaceable unit that is biased against an outer surface of a photoconductive drum of the replaceable unit from the outer surface of the photoconductive drum when the separator is installed on the replaceable unit. The separator includes a first electrically conductive contact positioned to electrically connect to the component and a second electrically conductive contact positioned to electrically connect to the photoconductive drum when the separator is installed on the replaceable unit. An electrical path is formed between the first electrically conductive contact and the second electrically conductive contact. The electrical path electrically connects the component and the photoconductive drum when the separator is installed on the replaceable unit such that a surface electrical potential of the component remains substantially the same as a surface electrical potential of the photoconductive drum.

A replaceable unit for an electrophotographic image forming device according to one example embodiment includes a photoconductive drum having an outer surface. A component is biased toward contact with the outer surface of the photoconductive drum. A separator is manually removable from the replaceable unit. The separator includes a separator portion physically separating the component from the outer surface of the photoconductive drum. The separator also includes a first electrically conductive contact electrically connected to the component and a second electrically conductive contact electrically connected to the photoconductive drum. An electrical path is formed between the first electrically conductive contact and the second electrically conductive contact electrically connecting the component and the photoconductive drum such that a surface electrical potential of the component remains substantially the same as a surface electrical potential of the photoconductive drum.

### BRIEF DESCRIPTION OF THE DRAWINGS

The accompanying drawings incorporated in and forming a part of the specification, illustrate several aspects of the present disclosure, and together with the description serve to explain the principles of the present disclosure.

FIG. 1 is a schematic view of an electrophotographic image forming device according to one example embodiment.

FIGS. 2A and 2B are perspective and exploded views, respectively, of a replaceable unit for an electrophotographic image forming device according to one example embodiment.

FIG. 3 is a perspective view of a prior art separator for a replaceable unit of an electrophotographic image forming device.

FIG. 4 is a perspective view of a separator for a replaceable unit of an electrophotographic image forming device according to one example embodiment.

FIGS. 5A and 5B are perspective views illustrating the separator shown in FIG. 4 installed on a replaceable unit.

FIG. 6 is a perspective view of a prior art cover for a replaceable unit of an electrophotographic image forming device.

FIG. 7 is a perspective view of cover for a replaceable unit of an electrophotographic image forming device according to one example embodiment.

FIG. 8 is a perspective view illustrating the cover shown in FIG. 7 installed on a replaceable unit.

### DETAILED DESCRIPTION OF THE DRAWINGS

In the following description, reference is made to the accompanying drawings where like numerals represent like elements. The embodiments are described in sufficient detail to enable those skilled in the art to practice the present disclosure. It is to be understood that other embodiments may be utilized and that process, electrical, and mechanical changes, etc., may be made without departing from the scope of the present disclosure. Examples merely typify possible variations. Portions and features of some embodiments may be included in or substituted for those of others. The following description, therefore, is not to be taken in a limiting sense and the scope of the present disclosure is defined only by the appended claims and their equivalents.

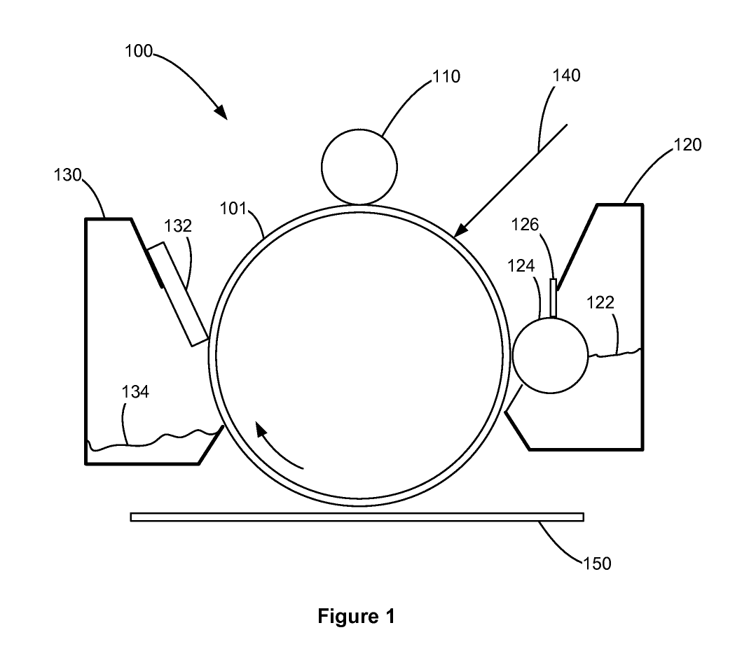

Referring now to the drawings, FIG. 1 illustrates a schematic representation of an example electrophotographic image forming device 100. Image forming device 100 includes a developer unit 120 and a cleaner unit 130. The electrophotographic printing process is well known in the art and, therefore, is described briefly herein. During a print operation, a charge roll 110 of cleaner unit 130 charges the surface of a photoconductive drum 101 in cleaner unit 130. The charged surface of photoconductive drum 101 is then selectively exposed to a laser light source 140 to form an electrostatic latent image on photoconductive drum 101 corresponding to the image being printed. Charged toner from developer unit 120 is picked up by the latent image on photoconductive drum 101 thereby creating a toned image.

Developer unit 120 includes a toner sump 122 having toner particles stored therein and a developer roll 124 that supplies toner from toner sump 122 to photoconductive drum 101. Developer roll 124 is electrically charged and electrostatically attracts the toner particles from toner sump 122. A doctor blade 126 disposed along developer roll 124 provides a substantially uniform layer of toner on developer roll 124 for subsequent transfer to photoconductive drum 101. As developer roll 124 and photoconductive drum 101 rotate, toner particles are electrostatically transferred from developer roll 124 to the latent image on photoconductive drum 101 forming a toned image on the surface of photoconductive drum 101. A toner adder roll (not shown) may also be provided to supply toner from toner sump 122 to developer roll 124. Further, one or more agitators (not shown) may be provided in toner sump 122 to distribute the toner therein and to break up any clumped toner.

The toned image is then transferred from photoconductive drum 101 to print media 150 (e.g., paper) either directly by photoconductive drum 101 or indirectly by an intermediate transfer member (not shown). A fusing unit (not shown) fuses the toner to print media 150. A cleaning blade 132 (or cleaning roll) of cleaner unit 130 removes any residual toner adhering to photoconductive drum 101 after the toner is transferred to print media 150. Waste toner from cleaning blade 132 is held in a waste toner sump 134 in cleaner unit 130. The cleaned surface of photoconductive drum 101 is then ready to be charged again and exposed to laser light source 140 to continue the printing cycle.

The components of image forming device 100 are replaceable as desired. For example, in one embodiment, developer unit 120 and cleaner unit 130 are housed in a replaceable unit with the main toner supply of image forming device 100. In another embodiment, developer unit 120 and cleaner unit 130 are provided in a first replaceable unit while the main toner supply of image forming device 100 is housed in a second replaceable unit.

In another embodiment, developer unit 120 is provided with the main toner supply of image forming device 100 in a first replaceable unit and cleaner unit 130 is provided in a second replaceable unit. It will be appreciated that any other combination of replaceable units may be used as desired. Further, in the case of an image forming device configured to print in color, separate replaceable units may be used for each toner color. For example, in one embodiment, the image forming device includes four developer units 120 and cleaner units 130, each corresponding to a particular toner color (e.g., black, cyan, yellow and magenta) and each replaceable as discussed above.

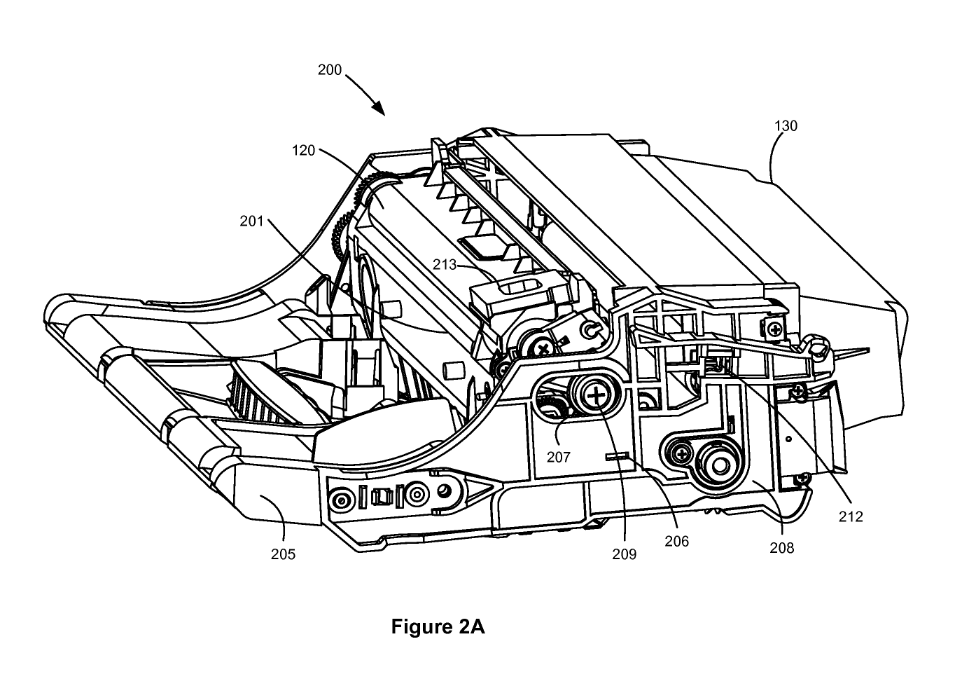

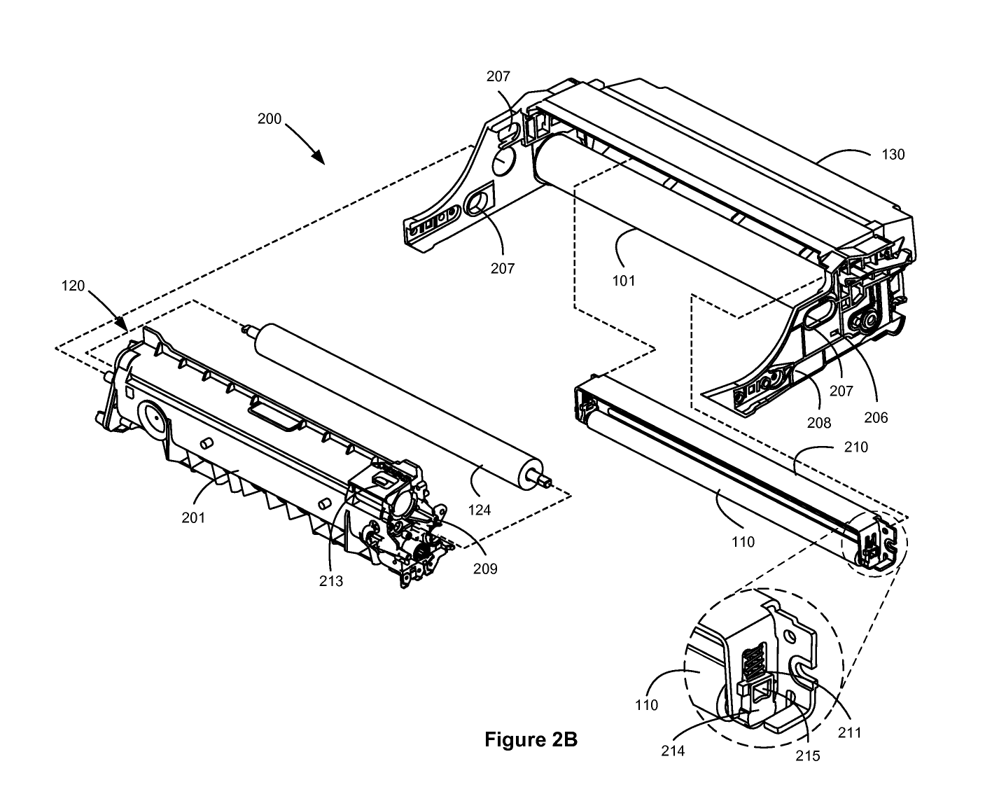

Referring now to FIGS. 2A and 2B, a replaceable imaging unit 200 for image forming device 100 is shown according to one example embodiment. Imaging unit 200 includes a developer unit 120 having a developer unit housing 201 and a cleaner unit 130 having a cleaner unit housing 208. Developer unit housing 201 and cleaner unit housing 208 are mounted on a common frame 205. Imaging unit 200 may be readily removed from image forming device 100 as desired in order to maintain, repair or replace the components associated with developer unit 120, cleaner unit 130 or frame 205.

Developer roll 124 is rotatably mounted on developer unit housing 201 with one end of developer roll 124 accessible through a slot 206 in the side of cleaner unit housing 208 as shown in FIG. 2A. Developer unit housing 201 includes an inlet port 213 positioned to receive toner from a corresponding toner cartridge (not shown) to replenish toner sump 122. Photoconductive drum 101 and charge roll 110 are rotatably mounted on cleaner unit housing 208.

During operation of image forming device 100, charge roll 110 and developer roll 124 are biased against and are in constant contact with photoconductive drum 101. For example, in the embodiment illustrated, developer unit housing 201 is movable relative to the cleaner unit housing 208. In this embodiment, one or more guide posts 209 on each side of developer unit housing 201 are positioned in corresponding elongated guide slots 207 on the sides of cleaner unit housing 208. Each guide post 209 can slide forward (to the left as viewed in FIG. 2A) and backward (to the right as viewed in FIG. 2A) in its corresponding elongated guide slot 207. In this manner, the engagement between guide posts 209 and guide slots 207 controls the freedom of motion between developer unit 120 and cleaner unit 130. A biasing device (not shown) such as, for example, one or more torsion springs positioned at the front of developer unit housing 201 (the left side of developer unit housing 201 as viewed in FIG. 2A) between developer unit housing 201 and frame 205 push the entire developer unit 120 rearward (to the right as viewed in FIG. 2A) toward cleaner unit housing 208 thereby pushing developer roll 124 into contact with photoconductive drum 101. The biasing device may include any suitable device including mechanical devices, such as a leaf or coil spring, or a material having resilient properties that bias developer unit housing 201 toward photoconductive drum 101. In other embodiments, developer unit housing 201 is fixed relative to cleaner unit housing 208 and developer roll 124 is biased directly or indirectly toward photoconductive drum 101.

In the embodiment illustrated, charge roll 110 is mounted on a charge roll bracket 210 positioned within cleaner unit housing 208. A charge roll bearing 214 is positioned at each end of charge roll 110 and mounted on charge roll bracket 210. Each charge roll bearing 214 receives and supports a corresponding end of a shaft of charge roll 110. A charge roll biasing device 211 biases each charge roll bearing 214 toward photoconductive drum 101 thereby pushing charge roll 110 into contact with photoconductive drum 101. In the example embodiment illustrated, biasing devices 211 apply a bias force to each of the charge roll bearings 214 to indirectly bias charge roll 110 relative to charge roll bracket 210. In other embodiments, charge roll bracket 210 is biased toward photoconductive drum 101 or the bias is applied directly to charge roll 110. In the example embodiment illustrated, each biasing device 211 is a compression spring mounted at one end to charge roll bracket 210 and another end to charge roll bearing 214; however, any suitable biasing device may be used including mechanical devices or a material having resilient properties as discussed above. Each charge roll bearing 214 includes a slot 215 that is open at the outer axial end of the bearing 214.

During storage or shipping, charge roll 110 and developer roll 124 are typically separated from photoconductive drum 101 to prevent chemical or physical damage to charge roll 110, developer roll 124 or photoconductive drum 101 that may result from prolonged, unmoved contact between charge roll 110 or developer roll 124 and photoconductive drum 101.

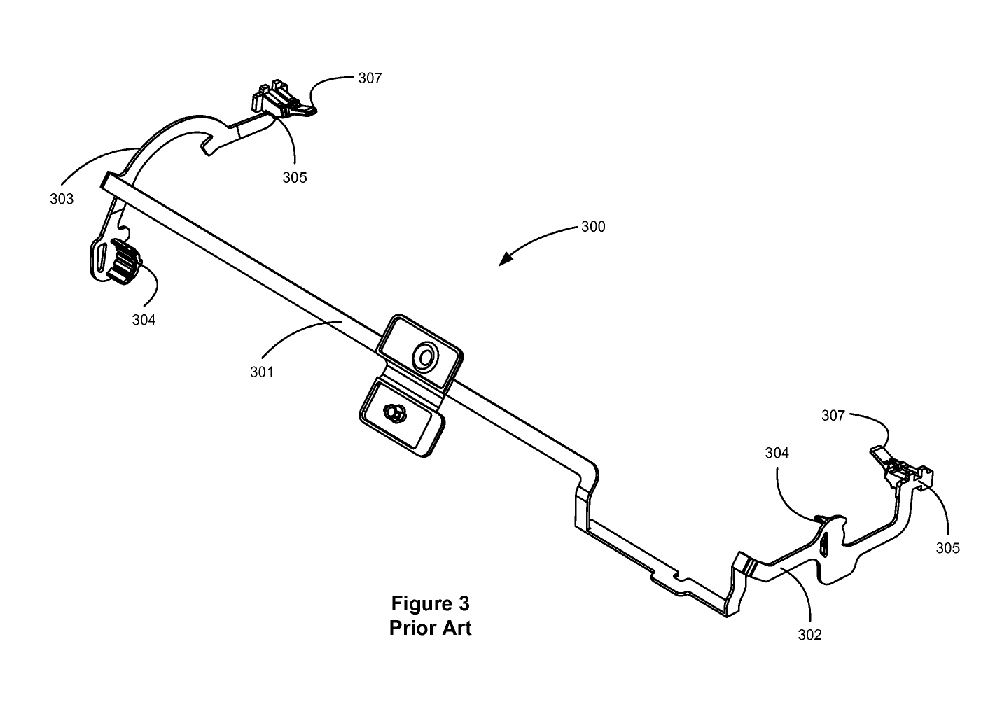

FIG. 3 shows a prior art separator 300 that is used during shipping or storage of a replaceable imaging unit 200. Separator 300 includes an elongated portion 301, a first arm 302 and a second arm 303 extending from first and second ends of elongated portion 301, respectively. Elongated portion 301 has a length that spans the width of imaging unit 200 along the axial lengths of the photoconductive drum 101, developer roll 124, and charge roll 110. First arm 302 and second arm 303 each include a developer roll separator 304 and a charge roll separator 305. When separator 300 is installed on a replaceable imaging unit 200, developer roll separator 304 physically separates developer roll 124 from photoconductive drum 101 and charge roll separator 305 physically separates charge roll 110 from photoconductive drum 101.

Each developer roll separator 304 is sized to fit through a corresponding guide slot 207 in cleaner unit housing 208. When installed, each developer roll separator 304 fits between one of the guide posts 209 on developer unit housing 201 and a rear end of the corresponding guide slot 207 to push the developer unit housing 201 away from cleaner unit housing 208 and photoconductive drum 101. Each developer roll separator 304 has a semi-circular shape to matably fit between a rear end of the guide post 209 and the rear end of the corresponding guide slot 207. When wedged between the rear ends of guide posts 209 and guide slots 207, developer roll separators 304 overcome the bias applied to developer unit housing 201 and push developer unit housing 201 forward (to the left as viewed in FIG. 2A) far enough to physically separate developer roll 124 from photoconductive drum 101.

Charge roll separators 305 are located at the ends of first arm 302 and second arm 303 of separator 300. Charge roll separators 305 are sized and shaped to closely fit through corresponding openings 212 (FIG. 2A) in cleaner unit housing 208. Each charge roll separator 305 includes a lift tab 307 that extends away from the respective first arm 302 or second arm 303 inward along the axial direction of photoconductive drum 101. Each lift tab 307 fits in the slot 215 of a corresponding charge roll bearing 214 when the charge roll separator 305 is inserted into its corresponding opening 212. When charge roll separators 305 are inserted through openings 212, lift tabs 307 enter slots 215 in charge roll bearings 214 and push up on charge roll bearings 214. The upward force applied by lift tabs 307 on charge roll bearings 214 overcomes the bias applied by biasing device 211 and raises charge roll bearings 214 and, in turn, charge roll 110 far enough to physically separate charge roll 110 from photoconductive drum 101. Lift tabs 307 are sufficiently rigid to retain bearings 214 in their raised positions when charge roll separators 305 are tightly installed in openings 212. The close fit engagement between charge roll separators 305 and the surfaces forming openings 212 provides the force necessary for lift tabs 307 to lift charge roll bearings 214.

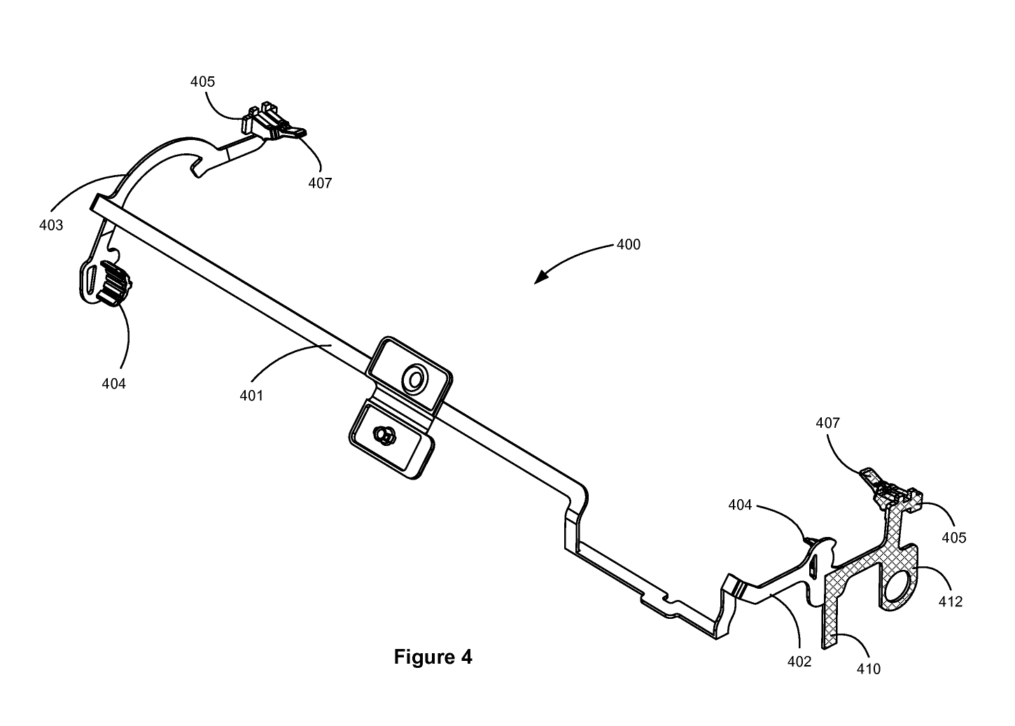

FIG. 4 shows a separator 400 according to one example embodiment. Separator 400 includes an elongated portion 401, a first arm 402 and a second arm 403 extending from first and second ends of elongated portion 401, respectively. Elongated portion 401 has a length that spans the width of imaging unit 200 along the axial length of the photoconductive drum 101, developer roll 124, and charge roll 110. First arm 402 and second arm 403 each include a developer roll separator 404 and a charge roll separator 405. When separator 400 is installed on a replaceable imaging unit 200, developer roll separators 404 physically separate developer roll 124 from photoconductive drum 101 in the manner discussed above with respect to separator 300 and charge roll separators 405 including lift tabs 407 physically separate charge roll 110 from photoconductive drum 101 in the manner discussed above with respect to separator 300.

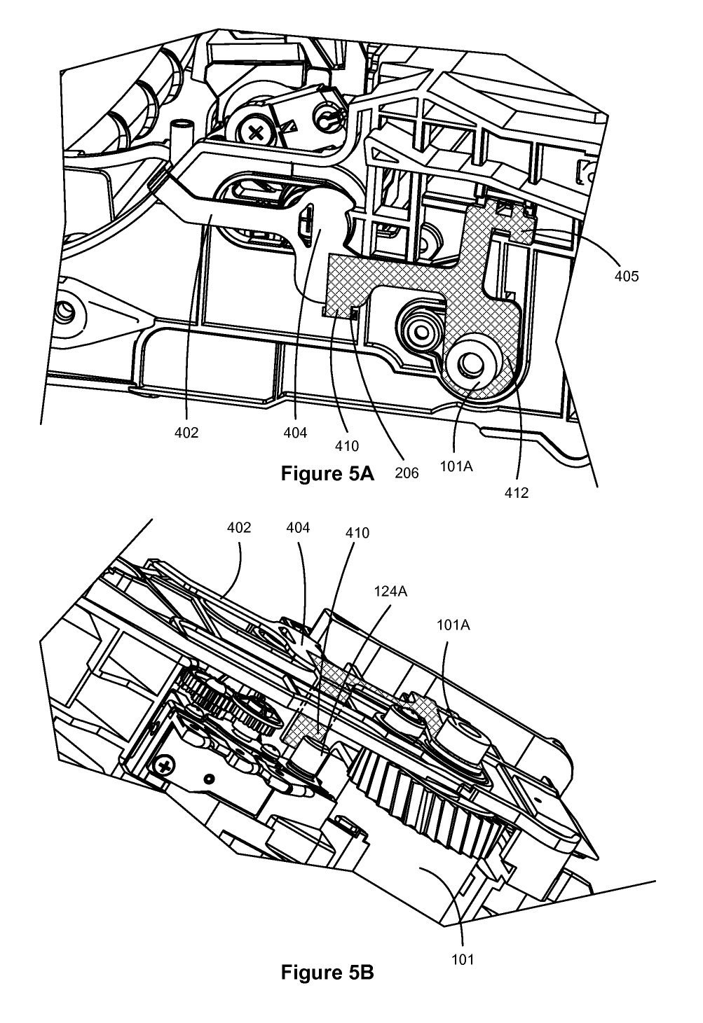

Separator 400 includes electrically conductive contacts positioned to electrically connect to photoconductive drum 101, developer roll 124 and charge roll 110, respectively. An electrical path is formed between the electrically conductive contacts to ground developer roll 124 and charge roll 110 relative to photoconductive drum 101 so that the surface electrical potentials of photoconductive drum 101, developer roll 124 and charge roll 110 remain substantially the same when separator 400 is installed on a replaceable imaging unit 200. For example, in the embodiment illustrated, tab 407 and charge roll separator 405 on first arm 402 form a first electrically conductive contact. When separator 400 is installed on a replaceable imaging unit 200, tab 407 physically contacts charge roll bearing 214, which is also electrically conductive, thereby establishing an electrical path between charge roll separator 405 of first arm 402 and charge roll 110. In the embodiment illustrated, a tab 410 that extends downward from first arm 402 substantially vertically in line with developer roll separator 404 forms a second electrically conductive contact. As shown in FIGS. 5A and 5B, when separator 400 is installed on a replaceable imaging unit 200, tab 410 passes through slot 206 in cleaner unit housing 208 and contacts an axial end of the shaft 124A of developer roll 124 thereby establishing an electrical path between tab 410 and developer roll 124. In the embodiment illustrated, a ring 412 that extends downward from first arm 402 substantially vertically in line with charge roll separator 405 forms a third electrically conductive contact. As shown in FIG. 5A, when separator 400 is installed on a replaceable imaging unit 200, ring 412 fits around and contacts an axial end of the shaft 101A of photoconductive drum 101 thereby establishing an electrical path between ring 412 and photoconductive drum 101. In this embodiment, tab 410, ring 412 and charge roll separator 405 including tab 407 are electrically conductive and electrically connected to each other through a common electrical path.

Accordingly, when separator 400 is installed on a replaceable imaging unit 200, a common electrical path is formed between charge roll 110, developer roll 124 and photoconductive drum 101 thereby substantially eliminating any surface electrical potential differential between charge roll 110, developer roll 124 and photoconductive drum 101 when they are physically separated. In this manner, any electrostatic buildup that imaging unit 200 accumulates during transport or storage may be discharged without creating a difference in the surface electrical potential between charge roll 110, developer roll 124 and photoconductive drum 101 thereby mitigating the risk of an electrostatic discharge between the surface of photoconductive drum 101 and the surface of either charge roll 110 or developer roll 124 and the associated print defects.

The electrical contacts and path may be formed by any suitable construction. For example, in one embodiment, tab 410, ring 412 and charge roll separator 405 including tab 407 are composed of and connected to each other by an electrically conductive material, such as electrically conductive plastic as indicated by the cross-hatching in FIGS. 4, 5A and 5B. In another embodiment, tab 410, ring 412 and charge roll separator 405 including tab 407 are covered by an electrically conductive film, such as a metal film, that also connects tab 410, ring 412 and charge roll separator 405 to each other. In another embodiment, the entire separator 400 is composed of an electrically conductive material, such as electrically conductive plastic.

Separator 400 may take many different forms and is not limited to the particular configuration illustrated. For example, separator 400 may physically separate one or more components as desired from photoconductive drum 101 and establish an electrical connection between photoconductive drum 101 and one or more of the separated component(s). The component(s) separated from and electrically connected to photoconductive drum 101 may include developer roll 124, charge roll 110, cleaning blade (or cleaning roll) 132 and/or any other component that is in contact with photoconductive drum 101 during the operation of image forming device 100. The particular manner by which separator 400 physically separates the component(s) from photoconductive drum 101 may vary depending on the arrangement of the component(s) relative to photoconductive drum 101 and the manner of biasing the component(s) toward photoconductive drum 101. Further, the manner by which electrical contact is made between separator 400 and the component(s) may vary as desired. For example, an electrically conductive contact of separator 400 may contact the component directly or the electrically conductive contact of separator 400 may contact another element that is electrically connected to the separated component, such as a bearing, a bracket, a fastener, a spring, an electrical contact of imaging unit 200 or any other element that is electrically connected to the separated component.

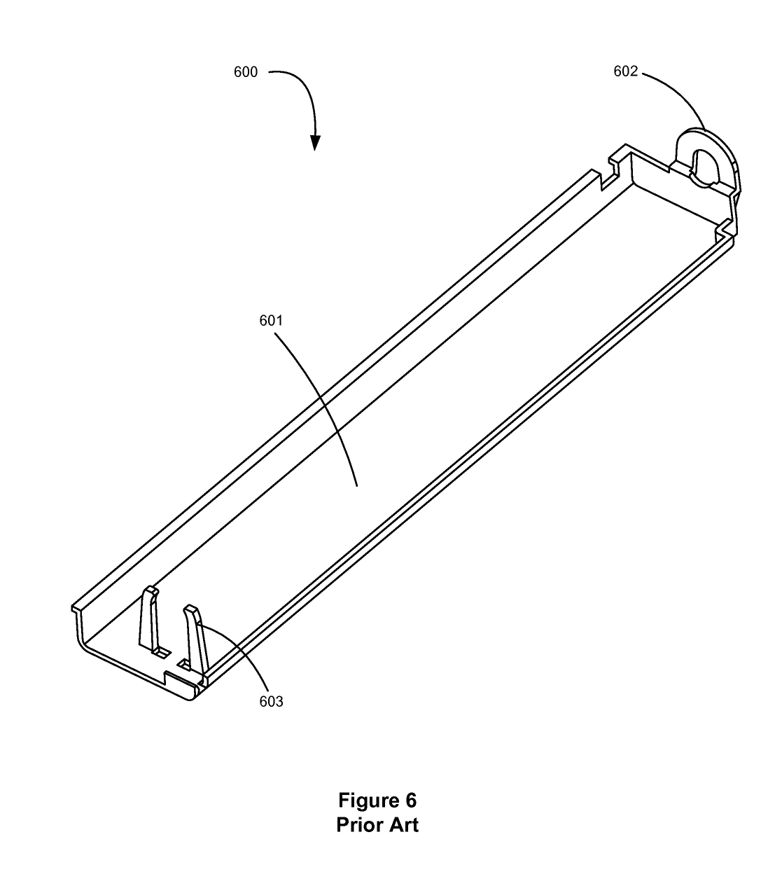

FIG. 6 shows a prior art cover 600 that is used during shipping or storage of a replaceable imaging unit 200 to cover an exposed portion of photoconductive drum 101 on a bottom side of imaging unit 200. Cover 600 includes an elongated body 601, a first securing member 602 and a second securing member 603 positioned at a first and a second end of cover 600, respectively. Body 601 has a length that spans the width of imaging unit 200 along the axial length of photoconductive drum 101. Body 601 has a width that is larger than the diameter of photoconductive drum 101 to cover an exposed portion of photoconductive drum 101.

Securing member 602 includes a ring shaped member that extends upward from body 601 at a first end of body 601. Securing member 602 receives a first axial end of photoconductive drum 101 when cover 600 is installed on imaging unit 200. Securing member 603 includes a pair of resilient arms that extend upward from body 601 at a second end of body 601. Securing member 603 removably snaps onto a second axial end of photoconductive drum 101 between the end of the photosensitive portion of photoconductive drum 101 and a drive coupler mounted coaxially with photoconductive drum 101 on the second axial end of photoconductive drum 101 when cover 600 is installed on imaging unit 200.

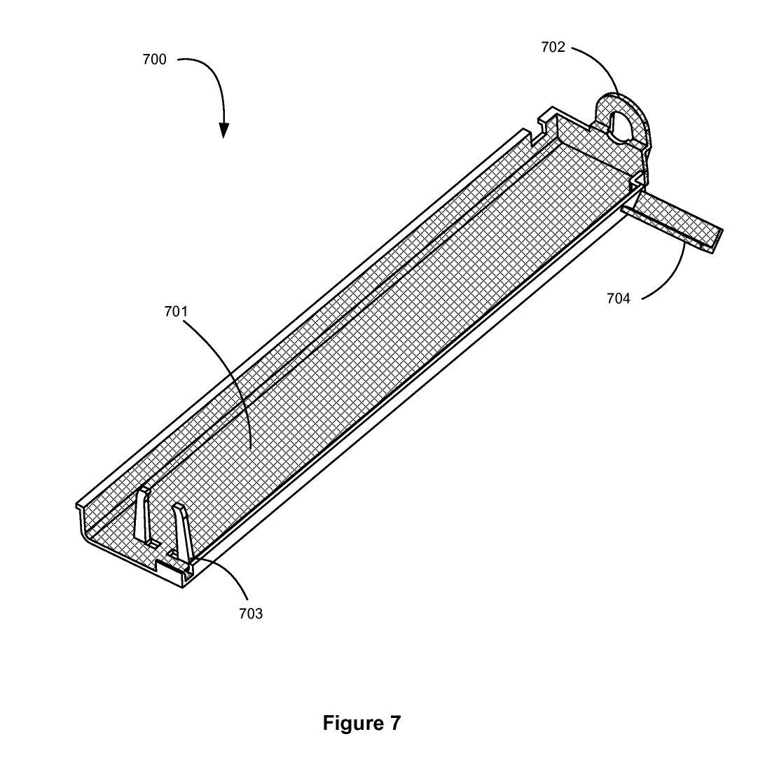

FIG. 7 shows a removable cover 700 according to one example embodiment. Removable cover 700 includes an elongated body 701, a first securing member 702 and a second securing member 703 positioned at a first and a second end of cover 700, respectively. Body 701 has a length that spans the width of imaging unit 200 along the axial length of photoconductive drum 101. Body 701 has a width that is sufficient to cover an exposed portion of the circumference of the outer surface of photoconductive drum 101. In some embodiments, the width of body 701 is at least the diameter of photoconductive drum 101 to ensure that the exposed portion of photoconductive drum 101 is covered by body 701 when cover 700 is installed on imaging unit 200. In one embodiment, securing member 702 and 703 mount on photoconductive drum 101 in the manner discussed above with respect to cover 600.

Cover 700 includes an electrically conductive contact positioned to electrically connect to photoconductive drum 101. For example, in the embodiment illustrated, securing member 702 serves as the electrically conductive contact and is positioned to contact the shaft of photoconductive drum 101 when cover 700 is installed on imaging unit 200. In one embodiment, cover 700 is composed of an electrically conductive material, such as an electrically conductive plastic, so that an electrical path is formed between cover 700 and photoconductive drum 101 when cover 700 is installed on imaging unit 200. In another embodiment, an inner side of body 701 adjacent to photoconductive drum 101 is covered with an electrically conductive material, such as metal. In this embodiment, the electrically conductive material is connected to the electrically conductive contact that is positioned to electrically connect to photoconductive drum 101. The electrical path formed between cover 700 and photoconductive drum 101 grounds cover 700 relative to photoconductive drum 101 to substantially eliminate any surface electrical potential differential between cover 700 and photoconductive drum 101. As a result, any electrostatic buildup that photoconductive drum 101 or cover 700 accumulates may be discharged without creating a difference in the surface electrical potential between photoconductive drum 101 and cover 700 thereby mitigating the risk of an electrostatic discharge between the surface of photoconductive drum 101 and cover 700.

In one embodiment, cover 700 includes an electrically conductive contact positioned to electrically connect to a component that is physically separated from photoconductive drum 101 during shipping or storage. An electrical path is formed between the electrically conductive contacts of cover 700 so that the surface electrical potentials of photoconductive drum 101 and the separated component remain substantially the same.

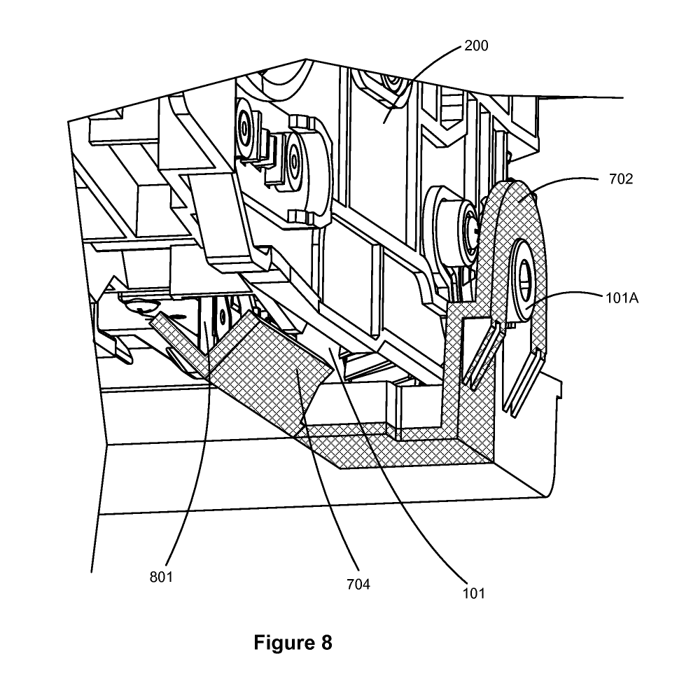

For example, in one embodiment, cover 700 includes an electrically conductive contact positioned to electrically connect to developer roll 124. In the example embodiment illustrated, cover 700 includes a finger 704 that extends forward (with respect to imaging unit 200) from the first end of cover 700 and forms an electrically conductive contact of cover 700. As shown in FIG. 8, when cover 700 is installed on imaging unit 200, finger 704 contacts an exposed portion of an electrical contact 801 on the bottom of developer unit 201. Electrical contact 801 is positioned to contact a corresponding electrical contact in image forming device 100 when imaging unit 200 is installed in image forming device 100. Electrical contact 801 receives an electric current from the corresponding electrical contact in image forming device 100. The electric current received by electrical contact 801 biases developer roll 124 to a desired voltage to promote the transfer of toner from developer roll 124 to the areas of photoconductive drum 101 exposed to laser light source 140. As a result, when cover 700 is installed on imaging unit 200, an electrical path is formed between developer roll 124, cover 700 and photoconductive drum 101 to ground developer roll 124 and cover 700 relative to photoconductive drum 101 so that the surface electrical potentials of developer roll 124, cover 700 and photoconductive drum 101 remain substantially the same when cover 700 is installed on imaging unit 200. Any electrostatic buildup that imaging unit 200 or cover 700 accumulates may be discharged without creating a difference in the surface electrical potential between developer roll 124, cover 700 and photoconductive drum 101 thereby mitigating the risk of an electrostatic discharge between the surface of photoconductive drum 101 and the surface of either cover 700 or developer roll 124.

The electrical contacts and path of cover 700 may be made of any suitable construction. For example, in one embodiment, cover 700 is composed of an electrically conductive material, such as electrically conductive plastic. In another embodiment, only portions of cover 700 are composed of and connected by an electrically conductive material as indicated by the cross-hatching in FIGS. 8 and 9. In another embodiment, cover 700 is composed of an electrically insulative plastic that includes portions covered by an electrically conductive film, such as a metal film, that connects securing member 702 and finger 704 to each other and covers an inner side of body 701 adjacent to photoconductive drum 101.

Cover 700 may take many different forms and is not limited to the particular configuration illustrated. For example, cover 700 may establish an electrical connection between photoconductive drum 101 and one or more components separated from photoconductive drum 101 during shipping or storage. The component(s) electrically connected to photoconductive drum 101 by cover 700 may include developer roll 124, charge roll 110, cleaning blade (or cleaning roll) 132 and/or any other component that is in contact with photoconductive drum 101 during the operation of image forming device 100 and separated from photoconductive drum 101 during shipping or storage. The manner by which electrical contact is made between cover 700 and the component(s) may vary as desired. For example, an electrically conductive contact of cover 700 may contact the component directly or the electrically conductive contact of cover 700 may contact another element that is electrically connected to the separated component, such as a bearing, a bracket, a fastener, a spring, an electrical contact of imaging unit 200 or any other element that is electrically connected to the separated component.

The foregoing description illustrates various aspects of the present disclosure. It is not intended to be exhaustive. Rather, it is chosen to illustrate the principles of the present disclosure and its practical application to enable one of ordinary skill in the art to utilize the present disclosure, including its various modifications that naturally follow. All modifications and variations are contemplated within the scope of the present disclosure as determined by the appended claims. Relatively apparent modifications include combining one or more features of various embodiments with features of other embodiments.

1. A manually removable separator for a replaceable unit of an electrophotographic image forming device, the separator comprising:
a separator portion positioned to physically separate a component of the replaceable unit that is biased against an outer surface of a photoconductive drum of the replaceable unit from the outer surface of the photoconductive drum when the separator is installed on the replaceable unit;
a first electrically conductive contact positioned to electrically connect to the component and a second electrically conductive contact positioned to electrically connect to the photoconductive drum when the separator is installed on the replaceable unit; and
an electrical path formed between the first electrically conductive contact and the second electrically conductive contact, the electrical path electrically connects the component and the photoconductive drum when the separator is installed on the replaceable unit such that a surface electrical potential of the component remains substantially the same as a surface electrical potential of the photoconductive drum.

2. The manually removable separator of claim 1, wherein the manually removable separator is composed entirely of an electrically conductive material.

3. The manually removable separator of claim 1, wherein the first electrically conductive contact includes an electrically conductive tab.

4. The manually removable separator of claim 1, further comprising:
a second separator portion positioned to physically separate a second component of the replaceable unit that is biased against the outer surface of the photoconductive drum of the replaceable unit from the outer surface of the photoconductive drum when the separator is installed on the replaceable unit; and
a third electrically conductive contact positioned to electrically connect to the second component when the separator is installed on the replaceable unit,
wherein the electrical path is formed between the first electrically conductive contact, the second electrically conductive contact and the third electrically conductive contact and the electrical path electrically connects the first component, the second component and the photoconductive drum when the separator is installed on the replaceable unit such that the surface electrical potential of the first component and a surface electrical potential of the second component remain substantially the same as the surface electrical potential of the photoconductive drum.

5. The manually removable separator of claim 4, wherein the first separator portion is positioned to physically separate a developer roll from the outer surface of the photoconductive drum and the second separator portion is positioned to physically separate a charge roll from the outer surface of the photoconductive drum when the separator is installed on the replaceable unit, wherein the first electrically conductive contact is positioned to electrically connect to the developer roll and the third electrically conductive contact is positioned to electrically connect to the charge roll when the separator is installed on the replaceable unit.

6. A replaceable unit for an electrophotographic image forming device, comprising:
a photoconductive drum having an outer surface;
a component biased toward contact with the outer surface of the photoconductive drum; and
a separator manually removable from the replaceable unit, the separator including:
a separator portion physically separating the component from the outer surface of the photoconductive drum;
a first electrically conductive contact electrically connected to the component and a second electrically conductive contact electrically connected to the photoconductive drum; and
an electrical path formed between the first electrically conductive contact and the second electrically conductive contact electrically connecting the component and the photoconductive drum such that a surface electrical potential of the component remains substantially the same as a surface electrical potential of the photoconductive drum.

7. The replaceable unit of claim 6, wherein the separator is composed entirely of an electrically conductive material.

8. The replaceable unit of claim 6, further comprising a second component biased toward contact with the outer surface of the photoconductive drum, wherein the separator includes:
a second separator portion physically separating the second component from the outer surface of the photoconductive drum; and
a third electrically conductive contact electrically connected to the second component,
wherein the electrical path is formed between the first electrically conductive contact, the second electrically conductive contact and the third electrically conductive contact electrically connecting the first component, the second component and the photoconductive drum such that the surface electrical potential of the first component and a surface electrical potential of the second component remain substantially the same as the surface electrical potential of the photoconductive drum.

9. The replaceable unit of claim 8, wherein the first component is a developer roll positioned to supply toner to the photoconductive drum and the second component is a charge roll positioned to electrically charge the outer surface of the photoconductive drum.

10. The replaceable unit of claim 6, wherein the component is a developer roll positioned to supply toner to the photoconductive drum.

11. The replaceable unit of claim 10, wherein the first electrically conductive contact includes a tab in contact with an axial end of a shaft of the developer roll.

12. The replaceable unit of claim 6, wherein the component is a charge roll positioned to electrically charge the outer surface of the photoconductive drum.

13. The replaceable unit of claim 10, wherein the first electrically conductive contact includes a tab in contact with an electrically conductive bearing that supports an axial end of a shaft of the charge roll.
